(19) United States
(12) Patent Application Publication
(10) Pub. No.: US 2014/0195167 A1
(43) Pub. Date: Jul. 10, 2014

(54) METHOD FOR EVALUATING THE AMOUNT OF TRITIUM ABSORBED BY A PERSON AFTER EXPOSURE TO AN ENVIRONMENT CONTAINING TRITIUM WITHOUT DRAWING BODY FLUID

(71) Applicant: Christophe Douche, Darois (FR)

(72) Inventor: Christophe Douche, Darois (FR)

(73) Assignee: COMMISSARIAT A L'ENERGIE ATOMIQUE ET AUX ENE ALT, Paris (FR)

(21) Appl. No.: 14/128,863

(22) PCT Filed: Jun. 27, 2012
(86) PCT No.: PCT/EP2012/062410

§ 371 Date: Feb. 12, 2014

(30) Foreign Application Priority Data
Jun. 30, 2011 (FR) 11 55905

(51) Int. Cl. G01T 1/02

(52) U.S. Cl. CPC G01T 1/02
USPC 702/19

(57) ABSTRACT

The invention relates to a method of estimating the tritium dose absorbed by a person exposed to an environment with a tritium atmosphere.

Applications of the invention include particularly dosimetric monitoring of tritium in persons exposed to an environment containing a significant amount of tritium during their activities, as is the case for the nuclear industry.

### TECHNICAL DOMAIN

This invention relates to a method for estimating the tritium dose absorbed by a person exposed to an environment with a tritium atmosphere.

The invention is more specifically related to a method of estimating the tritium dose absorbed by the body of this person without the need to draw off any of his or her body fluids.

Applications of the invention include particularly dosimetric monitoring of tritium in persons exposed to an environment containing a significant amount of tritium during their activities, as is the case for the nuclear industry.

### STATE OF PRIOR ART

Tritium, with chemical formula ³H, is an isotope of hydrogen permanently present in the environment in the form of tritiated water, tritiated organic material and gaseous tritium.

Tritium is naturally derived from the interaction between cosmic rays and the atmosphere, but can also be made artificially.

Currently, the artificial production of tritium in the environment originates from emissions from nuclear reactors, nuclear fuel waste treatment plants and also the manufacture of thermonuclear weapons.

The risk incurred by a person exposed to a tritium source is not related to an “outside the body” contamination, that is to say a contamination involving external action of tritium on the body, since the ionizing radiation emitted by tritium is not intense enough to break through the barrier of the skin or cornea.

Conversely, tritium can enter the body of a person by a route “inside the body”, in other words through his or her respiratory tracts, skin exposure and/or digestive tracts.

The tritium dose absorbed by persons working in the tritium industry is regularly monitored by means of sampling and analysis of body fluids, particularly urine, to satisfy the requirements of the regulations.

Currently, the analysis of urine samples of these workers by liquid scintillation spectroscopy is a well-controlled and widely used technique. It consists of mixing tritiated urine with a scintillation liquid to transform ionising radiation derived from the radioactive decay of tritium into light that is easily detected and quantified by spectroscopy.

However, in this type of process combining a urine sample with a liquid scintillation spectroscopy analysis, it is usually necessary to wait for a balance of body fluids to be reached inside the body of the person before taking the urine sample, which requires a time delay of about two hours after exposure to a tritiated environment.

Moreover since urine is a biological sample, after it has been taken it must be analysed by a medical test laboratory.

Therefore, such a method cannot give a fast quantification of the tritium dose absorbed by the body of said person, which may be a problem for a person visiting premises with a tritium atmosphere.

The inventors set themselves the objective of developing a method for making a fast estimate of the tritium dose absorbed by a person exposed to a tritiated environment, to overcome the above-mentioned disadvantages.

They also set themselves the objective that this method should not involve taking body fluid samples and that it can be put into practice autonomously, that is to say without having to call in an external body such as a medical test laboratory.

### PRESENTATION OF THE INVENTION

This invention achieves these and other objectives based on the fact the inventors have discovered that the tritium dose absorbed by a person in a tritiated environment can be estimated without the need to take a body fluid sample from said person.

The invention thus relates to a method for estimating the tritium dose absorbed by a person (called the “Dose” in the following, expressed in Sieverts (Sv)) after exposure of said person to a tritiated environment for a duration τ (expressed in hours (h)), said method comprising the following steps:

a) a step to measure the activity per unit volume of tritium present in said environment (denoted C_{HTO} and expressed in Becquerels per litre (Bq/L));

b) a step to estimate the dose absorbed by said person, using the following relation:

Dose=C_{HTO}×τ×DPUI_{HTO}×1800,

in which:
C_{HTO} is the activity per unit volume of tritium (expressed in Becquerels per litre (Bq/1)) measured in the previous step a); and
DPUI_{HTO} is equal to 1.8.10⁻¹¹ Sieverts per Becquerel (Sv/Bq).

From a practical point of view, DPUI_{HTO} is the effective dose factor per unit intake for tritiated water vapour (also commonly referred to as “dose factor”).

Further information about tritium will be provided in the following paragraphs to give a better understanding of the work done by the inventors.

Thus, it is recalled that tritium is a radioactive isotope that decays, releasing energy in the form of beta radiation (β⁻), in other words by emitting an electron and an antineutrino.

Also, the expression “tritium dose absorbed by a person” means the tritium dose that the inventors want to estimate and that may be absorbed by a person at the end of his or her exposure to the tritiated environment during an exposure time τ (expressed in hours (h)). This physical quantity is expressed in Sieverts (Sv).

Finally, we use the term “tritiated environment” to refer to an environment containing tritium. In this application, the terms “environment containing tritium”, “environment with tritium atmosphere” or simply “tritium atmosphere” may also be used to mean the same thing.

As mentioned above, this invention relates to a method that takes place in two steps and is capable of estimating the tritium dose that a person might have absorbed in his or her body, by measuring the activity per unit volume of tritium in the tritiated environment to which the person is exposed.

Therefore the first step or step a) is to measure the activity per unit volume of tritium (expressed in Becquerels per litre (Bq/L)) present in the tritiated environment to which the person is exposed for the duration of exposure τ.

This step may consist in particular of bubbling air from the tritiated environment in a given volume of water in a bubbler at constant rate during said duration τ, measuring the activity of tritium (expressed in Becquerels (Bq)) trapped in said volume of water, for example by liquid scintillation spectroscopy, and then deducing the activity per unit volume of tritium present in the tritiated environment (denoted C_{HTO} and expressed in Becquerels per litre (Bq/L)) using the following relation:

$${C}_{HTO} = \frac{{I}_{HTO}}{η \times V} ,$$

in which:
I_{HTO} is the activity of tritium (expressed in Becquerels (Bq)) trapped in the volume of water mentioned above;
η is the efficiency at which tritium is trapped in this volume of water and which depends on the bubbler used, and can be between 0.8 and 1, and
V is the volume of air (in litres (L)) that circulated in the above-mentioned volume of water.

The term “tritium capture efficiency” is the ratio η of the activity of tritium trapped in the water by bubbling to the activity of tritium contained in the air volume V that circulated in the abovementioned volume of water.

Liquid scintillation spectroscopy is a technique that consists of mixing a tritiated radioactive solution with a scintillation liquid to transform the ionising radiation caused by radioactive decay of tritium into light that can be easily detected and quantified by spectroscopy.

The second step of the method or step b) estimates the dose absorbed by said person using the following relation:

Dose=C_{HTO}×τ×DPUI_{HTO}×1800,

in which C_{HTO} is the activity per unit volume of tritium (expressed in Becquerels per litre (Bq/L)) present in the tritiated environment that is measured during the first step, or step a).

In this relation, the value “1800” is an average penetration rate of air in the tritiated environment into the body of the person, as will be defined in the example below.

Therefore this value is expressed in litres per hour (L/h) and means that the person present in a tritiated environment absorbs 1800 litres of air per hour from the tritiated environment into his or her body through respiratory tracts and skin exposure.

Other characteristics and advantages of the invention will become clear after reading the following description that relates to a demonstration of the approach used by the inventors to develop the method described above for estimating the tritium dose absorbed by the person, followed by an example application of said method.

Obviously, this additional description is given solely as an illustration of the invention and is in no way limitative.

### BRIEF DESCRIPTION OF THE DRAWINGS

FIG. 1 is a diagrammatic representation of the portable bubbler used by the inventors to estimate the activity per unit volume of tritium present in the environment in the premises visited by a person.

### DETAILED PRESENTATION OF THE PARTICULAR EMBODIMENT

### Example

Estimation of the dose of tritium ³H absorbed by a person who was present for a time τ in a room containing a tritiated environment.

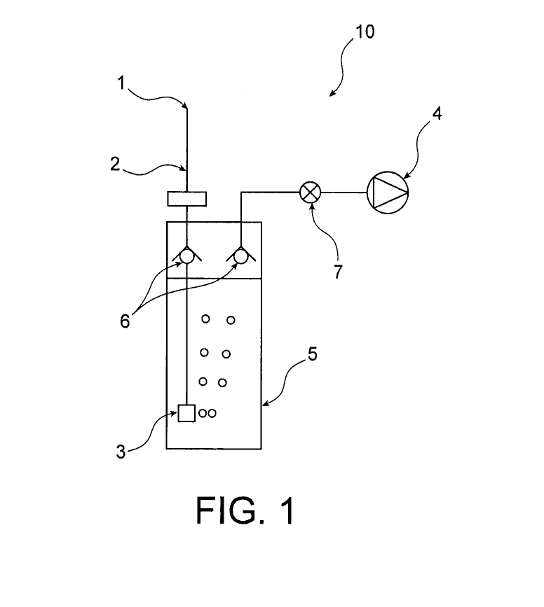

The first step in estimating the tritium dose absorbed by the person after his or her visit to premises containing a tritiated environment is to use a portable bubbler 10 shown diagrammatically in FIG. 1 to determine the activity per unit volume of tritium present in the tritiated environment in which the person was present during his or her visit during the exposure time τ.

As shown in FIG. 1, this experimental device 10 includes an air inlet 1 leading to a duct 2 fitted with an air diffuser 3 at its end which, by actuating a pump 4, bubbles air from the tritiated environment in 100 ml of water filling a 150 ml reservoir 5.

It is also fitted with two float valves 6 for controlling the water level in the reservoir 5, and a device 7 for measuring the volume of air that passed through the device during the time τ that the person is present in the room.

The person wears this device on his or her belt and switches it on when entering the room and switches it off when leaving it. This is done by switching the pump 4 on and off, the air inflow being fixed by the flow rate of the pump, this flow rate being constant.

Therefore during the visit to the room, the portable device in operation bubbles air in the tritiated environment through the 100 ml of water in reservoir 5, with the result that the tritium present in the air drawn in by pump 4 becomes trapped in the water in the reservoir.

Tritium in the air exists in two main forms, namely gaseous (denoted HT) and in the form of tritiated water vapour (denoted HTO).

Since the dose coefficient (or dose factor) in the HT form (equal to 1.8×10⁻¹⁵ Sv/Bq) is 10000 times lower than the dose coefficient (or dose factor) in the HTO form (equal to 1.8×10⁻¹¹ Sv/Bq), the contribution of tritium in the HT form to the real dose of tritium ³H absorbed by the person at the end of his or her stay in the room with a tritiated environment is assumed to be negligible compared with the contribution of tritium in the HTO form.

Thus in the following, the basic principle is that the activity per unit volume of tritium present in the tritiated environment is equivalent to the activity per unit volume of tritium in the form of tritiated water vapour (hereinafter denoted C_{HTO).}

When the person leaves the room and the device is switched off, a volume Vₚ equal to between 1 and 10 ml of water is drawn off from that reservoir.

The drawn off volume Vₚ is then transferred into a 20 ml analysis vial in which it is mixed with 10 ml of scintillation liquid. The activity of tritium A_{HTO} by liquid scintillation spectroscopy is then quantified.

Knowing the volume of water V_{Res} present in the reservoir after bubbling and the tritium activity A_{HTO} in the sampled water volume Vₚ, it is easy to deduce the total activity of tritium trapped in the reservoir, denoted I_{HTO} using the following equation:

$${I}_{HTO} = \frac{{A}_{HTO}}{{V}_{p}} \times {V}_{res} ,$$

in which I_{HTO} is expressed in Becquerels (Bq), A_{HTO} in Becquerels (Bq), Vₚ in litres (L) and Vᵣₑₛ in litres (L).

Since the total activity I_{HTO} of tritium present in the reservoir has been determined, an estimate of the activity per unit volume of tritium (denoted C_{HTO} and expressed in Becquerels per litre (Bq/L)) present in the tritiated environment is deduced using the following relation

$${C}_{HTO} = \frac{{I}_{HTO}}{V \times η}$$

in which:
V is the volume of air (expressed in litres (L)) that circulated in the reservoir during the visit duration T (expressed in hours (h)); and
η is the trapping efficiency of the device, equal to 0.8 in this case.

Since the activity per unit volume C_{HTO} of tritium present in the tritiated environment is now known, an attempt is made to estimate the tritium dose that the person has absorbed into his or her body during the visit.

This is done considering the total quantity of tritium that was absorbed by the person's body through the respiratory tracts and skin exposure at ratios of ⅔ and ⅓ respectively (for a person without any protection equipment).

Since the average respiratory flowrate of a normal person, denoted Dᵣₑₛₚ, is equal to 1200 litres per hour (L/h), an average penetration rate of air from the tritiated environment into the body, denoted Dₚ, is determined by the following relation:

$$\begin{matrix}{D}_{p} = {D}_{resp} + {D}_{skin} \\ = {D}_{resp} + \frac{{D}_{resp}}{2} \\ = 1200 + 600 \\ = 1800 L / h .\end{matrix}$$

The tritium activity absorbed by the person visiting a room with a tritiated environment, denoted Iᵢₙₜ and expressed in Becquerels (Bq), is simply the product of the activity per unit volume C_{HTO} of tritium present in the tritiated environment and the rate of absorption of tritium by the body and the exposure time τ to the tritiated environment, namely by the following relation:

Iᵢₙₜ=C_{HTO}×τ×1800.

The dose absorbed by the person, denoted <<Dose>> and expressed in Sieverts (Sv), is determined by the product of the activity per unit volume of tritium absorbed by the person Iᵢₙₜ and the dose factor of tritium in the form of water vapour DPUI_{HTO}, namely by the following relation:

Dose=Iᵢₙₜ×DPUI_{HTO},

or otherwise:

Dose=C_{HTO}×τ×1800×DPUI_{HTO}.

Thus, through the use of all the relations given above, the dose absorbed by a person visiting a room containing a tritiated environment for a duration τ is determined by the following general relation:

$$Dose = \frac{{A}_{HTO} \times {V}_{r {e}^{′} s} \times 1800 \times {DPUI}_{HTO} \times τ}{{V}_{p} \times V \times η} ,$$

in which:
A_{HTO} is the tritium activity (expressed in Becquerels (Bq)) present in the volume Vₚ of water (expressed in litres (L)) that is drawn off from the reservoir containing a volume Vᵣₑₛ of water (expressed in litres (L));
DPUI_{HTO} is the dose factor of tritium in the form of water vapour, and equal to 1.8×10 ⁻¹¹ Sieverts per Becquerel (Sv/Bq);
τ is the duration of the visit in the room with a tritiated environment (expressed in hours (h));
V is total volume of air in the tritiated environment drawn in by the bubbler during the visit (expressed in litres (L)); and
η is the efficiency at which tritium present in the tritiated environment is trapped in the water in the bubbler.

Thus in this example, for a drawn off volume Vₚ equal to 10 ml, a water volume in the reservoir Vᵣₑₛ equal to 100 ml, a trapping efficiency η of 0.8, a tritium activity A_{HTO} measured by liquid scintillation spectroscopy equal to 1 Becquerel (Bq) and a visit duration τ of one hour, the tritium dose absorbed by the visitor is estimated to be equal to 0.04 microSieverts (μSv).

1. Method for estimating the tritium dose (expressed in Sieverts (Sv)) absorbed by a person after exposure of said person to a tritiated environment for a duration τ (expressed in hours(h), said method comprising the following steps:
a) a step to measure the activity per unit volume of tritium present in said environment (denoted C_{HTO} and expressed in Becquerels per litre (Bq/L));
b) a step to estimate the dose absorbed by said person, using the following relation:
Dose=C_{HTO}×τ×DPUI_{HTO}×1800,
in which:
C_{HTO} is the activity per unit volume of tritium (expressed in Becquerels per litre (Bq/1)) measured in the previous step a); and
DPUI_{HTO} is equal to 1.8×10⁻¹¹ Sieverts per Becquerel (Sv/Bq).

2. Method according to claim 1, in which step a) consists of bubbling air from the tritiated environment in a given volume of water in a bubbler at constant rate during said duration τ, measuring the activity of tritium (expressed in Becquerels (Bq)) trapped in said volume of water, and then deducing the activity per unit volume of tritium present in the tritiated environment (denoted C_{HTO} and expressed in Becquerels per litre (Bq/L)) using the following relation:
$${C}_{HTO} = \frac{{I}_{HTO}}{η \times V} ,$$
in which:
I_{HTO} is the activity of tritium (expressed in Becquerels (Bq)) trapped in the volume of water mentioned above;
η is the efficiency at which tritium is trapped in this volume of water; and
V is the volume of air (expressed in litres (L)) that circulated in the above-mentioned volume of water.

3. Method according to claim 2, in which η is between 0.8 and 1.
